(19) United States
(12) Patent Application Publication
(10) Pub. No.: US 2007/0100706 A1
(43) Pub. Date: May 3, 2007

(54) System and method for order verification

(76) Inventors: David Raccah, San Jose, CA (US); Alok Bhanot, Hillsborough, CA (US); Srinivasan Raman, Cupertino, CA (US); Charles Dale Fletcher, San Jose, CA (US)

Correspondence Address: SCHWEGMAN, LUNDBERG, WOESSNER & KLUTH/EBAY, P.O. BOX 2938, MINNEAPOLIS, MN, 55402, US

(21) Appl. No.: 11/323,859

(22) Filed: Dec. 30, 2005

Related U.S. Application Data
(60) Provisional application No. 60/731,682, filed on Oct. 31, 2005.

(51) Int. Cl. G06Q 30/00

(52) U.S. Cl. 705/26

(57) ABSTRACT

A system and method provides a user of a network-based commerce facility the ability to either purchase all of the items in his electronic shopping cart, to purchase some of the items in his electronic shopping cart, or to purchase none of the items in his electronic shopping cart.

### PRIORITY

This application claims the benefit of previously filed U.S. Provisional Application 60/731,682, filed on Oct. 31, 2005, which is herein incorporated in its entirety for all purposes.

### TECHNICAL FIELD

Various embodiments relate generally to the fields of network-based transaction facilities and commerce automation, and in particular, but not by way of limitation, to a system and method for order processing and confirmation in a network-based transaction facility.

### BACKGROUND

The Internet and the World Wide Web provide access to a tremendous amount of products and information. Many sites on the World Wide Web are referred to as E-commerce sites that permit a user to log on to the site, shop for goods and services online, add the goods and services desired to be purchased into an electronic shopping cart, submit the order to the E-commerce facility's server, and have the goods delivered to the user. In a typical E-commerce site, a user submits an order with payment for the goods in his electronic shopping cart. The E-commerce server accepts and fills that order for all the goods in the cart that are presently available. If goods in the cart are not available at the time of order submission, the order may be processed (and the user charged) absent the unavailable goods. At least one unfortunate consequence of such systems is that a consumer may only have wanted certain items if another specific item or items were available. For example, a user may not want the CDs in his cart if the CD player in his cart is not available.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram illustrating an example network-based transaction facility.

FIG. 2 is a database diagram illustrating an example database for the network-based transaction facility of FIG. 1.

FIG. 3 is a diagrammatic representation of an example transaction record table of the database illustrated in FIG. 2.

FIG. 4 is a diagrammatic representation of an example item database.

FIG. 5 is a diagrammatic representation of an example shopping cart database.

FIG. 6 is a block diagram illustrating another example network-based transaction facility.

FIGS. 7A and 7B illustrate flowcharts of a process that may be used in connection with the network-based transaction facility of FIG. 6.

FIG. 8 illustrates an example computer system upon which one or more order processing and confirmation embodiments may execute.

### DETAILED DESCRIPTION

A system and method for order processing and confirmation in a networked environment are described. In the following description, for purposes of explanation, numerous specific details are set forth in order to provide a thorough understanding of the present invention. It will be evident, however, to one skilled in the art that the present invention may be practiced without these specific details.

### Terminology

For the purposes of the present specification, the term “transaction” shall be taken to include any communications between two or more entities and shall be construed to include, but not be limited to, commercial transactions including sale and purchase transactions, auctions and the like.

### Transaction Facility

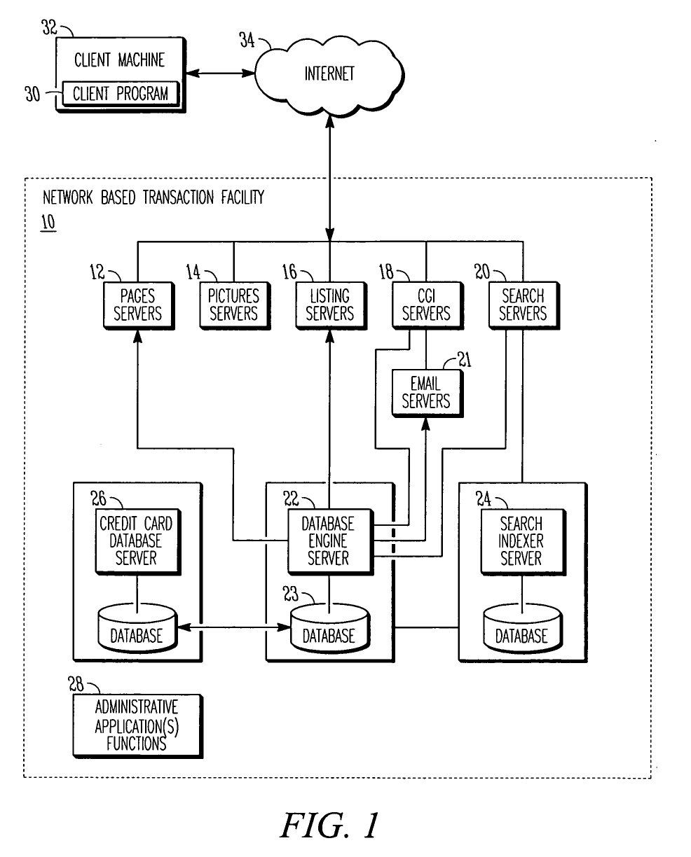

FIG. 1 is block diagram illustrating an example network-based transaction facility 10 that includes one or more of a number of types of front-end servers, namely page servers 12 that deliver web pages (e.g., markup language documents), picture servers 14 that dynamically deliver images to be displayed within Web pages, listing servers 16, CGI servers 18 that provide an intelligent interface to the back-end of facility 10, and search servers 20 that handle search requests to the facility 10. E-mail servers 21 provide, inter alia, automated e-mail communications to users of the facility 10.

The back-end servers include a database engine server 22, a search index server 24 and a credit card database server 26, each of which maintains and facilitates access to a respective database.

The facility 10 may be accessed by a client program 30, such as a browser (e.g., the Internet Explorer distributed by Microsoft Corp. of Redmond, Wash.) that executes on a client machine 32 and accesses the facility 10 via a network such as, for example, the Internet 34. Other examples of networks that a client may utilize to access the auction facility 10 include a wide area network (WAN), a local area network (LAN), a wireless network (e.g., a cellular network), or the Plain Old Telephone Service (POTS) network.

### Database Structure

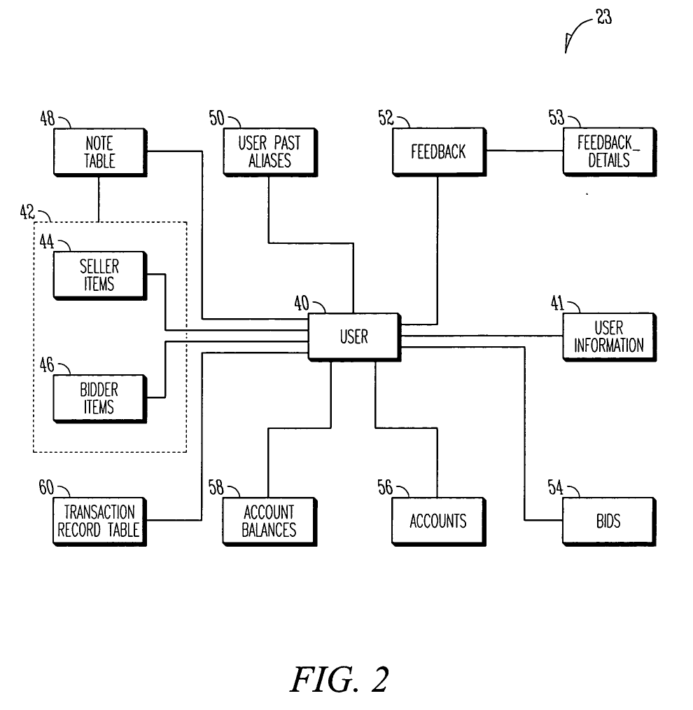

FIG. 2 is a database diagram illustrating an example database 23, maintained by and accessed via the database engine server 22, which at least partially implements and supports the network-based transaction facility 10 such as an Internet-based auction facility, an E-commerce facility, a network-based payment service provider, and/or a network-based publication facility.

The database 23 may, in one embodiment, be implemented as a relational database, and may include a number of tables having entries, or records, that are linked by indices and keys. In an alternative embodiment, the database 23 may be implemented as a collection of objects in an object-oriented database.

Central to the database 23 is a user table 40, which contains a record for each user of the network-based transaction facility 10. A user may operate as a seller, a buyer, or both, within the facility 10. The database 23 also includes item tables 42 that may be linked to the user table 40. Specifically, the tables 42 include a seller items table 44 and a bidder items table 46. A user record in the user table 40 may be linked to multiple items that are being, or have been, auctioned via the facility 10. A link indicates whether the user is a seller or a buyer with respect to items for which records exist within the item tables 42. The database 23 also includes a note table 48 populated with note records that may be linked to one or more item records within the item tables 42 and/or to one or more user records within the user table 40. Each note record within the table 48 may include, inter alia, a comment, description, history or other information pertaining to an item being offered via the facility 10, or to a user of the facility 10.

A number of other tables are also shown to be linked to the user table 40, namely a user past aliases table 50, a feedback table 52, a feedback details table 53, a bids table 54, an accounts table 56, an account balances table 58 and a transaction record table 60.

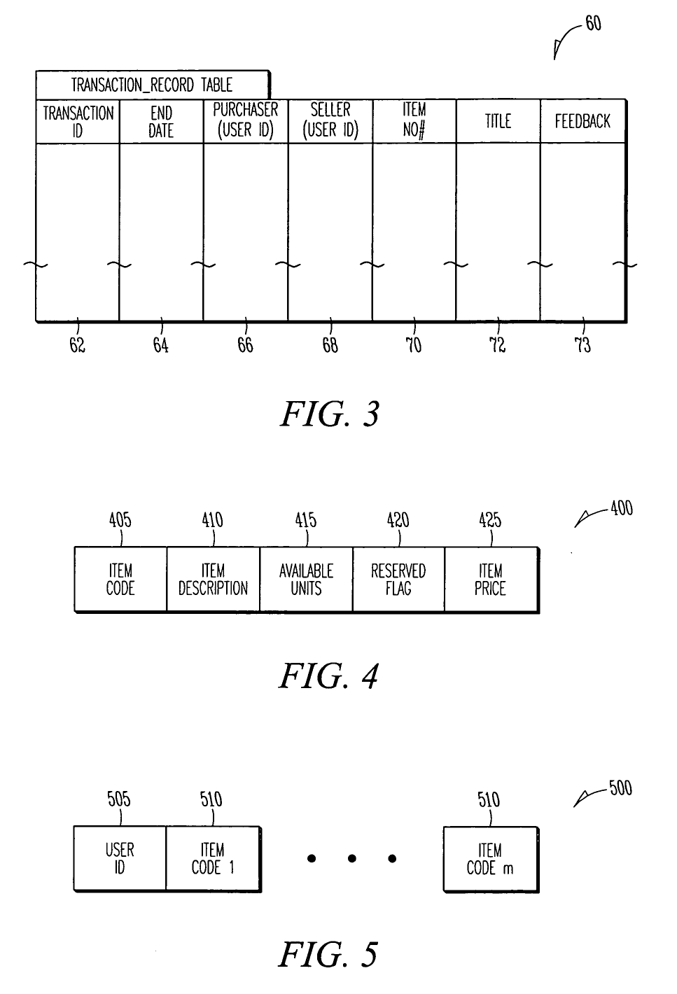

FIG. 3 is a diagrammatic representation of an example embodiment of the transaction record table 60 that is populated with records, or entries, for completed, or ended, transactions that have been facilitated by the facility 10. The table 60 includes a transaction identifier column 62 that stores a unique transaction identifier for each entry, and an end date column 64 that stores a date value indicating, for example, a date on which a transaction was established. A purchaser column 66 stores a user identifier for a purchaser, the user identifier comprising a pointer to further user information stored in the user table 40. Similarly, a seller column 68 stores, for each entry, a user identifier for a seller within the relevant transaction. An item number column 70 stores, for each entry, an item number identifying the goods or service being transacted, and a title column 72 stores, for each entry, a descriptive title for the relevant transaction or for the item being transacted. A feedback column 73 stores, for each entry, data specifying whether feedback exists for the relevant transaction and whether this feedback is current (e.g., has not been removed or withdrawn).

It should be noted that, in one embodiment, an entry is only created in the transaction record table 60 for transactions that have been established by some offer and acceptance mechanism between the purchaser and the seller.

FIG. 4 illustrates an example embodiment of an items table record 400. In an embodiment, the seller items table 44 of FIG. 2 uses this structure. Referring to FIG. 4, the items table record 400 includes an item identifier or code 405, an item description 410, an available units field 415, a reserved flag 420, and an item price field 425. FIG. 5 illustrates an example embodiment of a shopping cart database record 500. The shopping cart database record 500 includes a user id code 505, and one or more item identifiers or codes 510 corresponding to each item that a user has placed into a cart. The item identifiers 510 may be used to relate each item in a user's shopping cart to the record for that item in the item table 400.

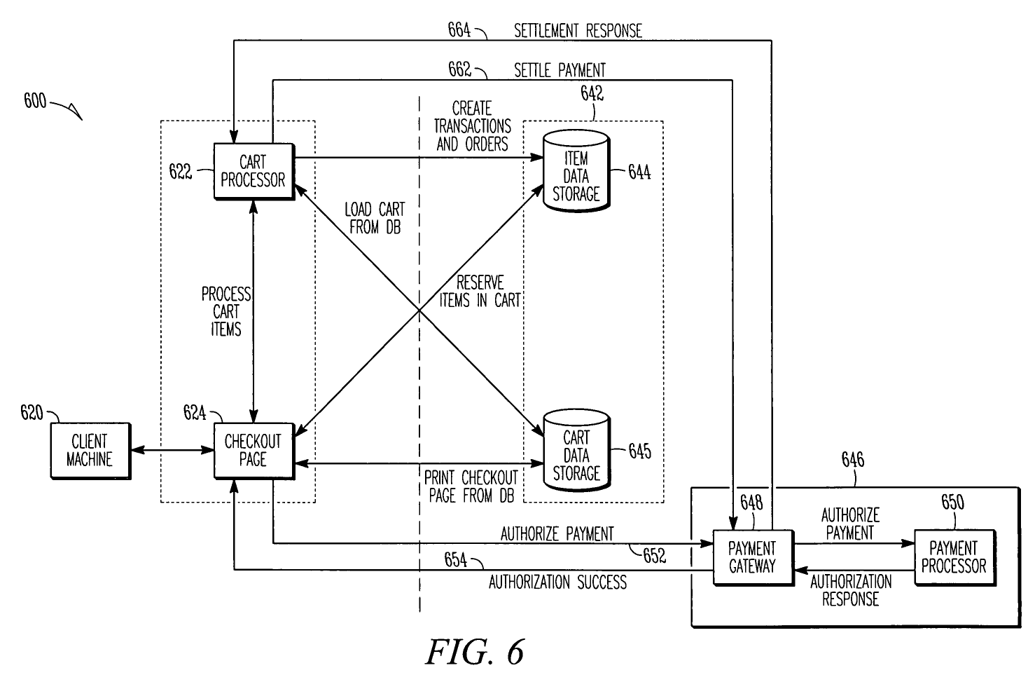

FIG. 6 illustrates another embodiment of a commerce system 600. The system 600 of FIG. 6 includes a client machine 620 that can display pages from a server side web site. The embodiment of FIG. 6 further includes a checkout page server 624, a cart processor server 622, and a network-based transaction facility 642 that includes an item data storage structure (e.g., a table or database) 644 and a cart data storage structure (e.g., a table or database) 645. The system 600 further includes a payment server 646, which includes a payment gateway 648 and a payment processor 650. In another embodiment, the payment server 646 and the network-based transaction facility 642 may be resident on one server site.

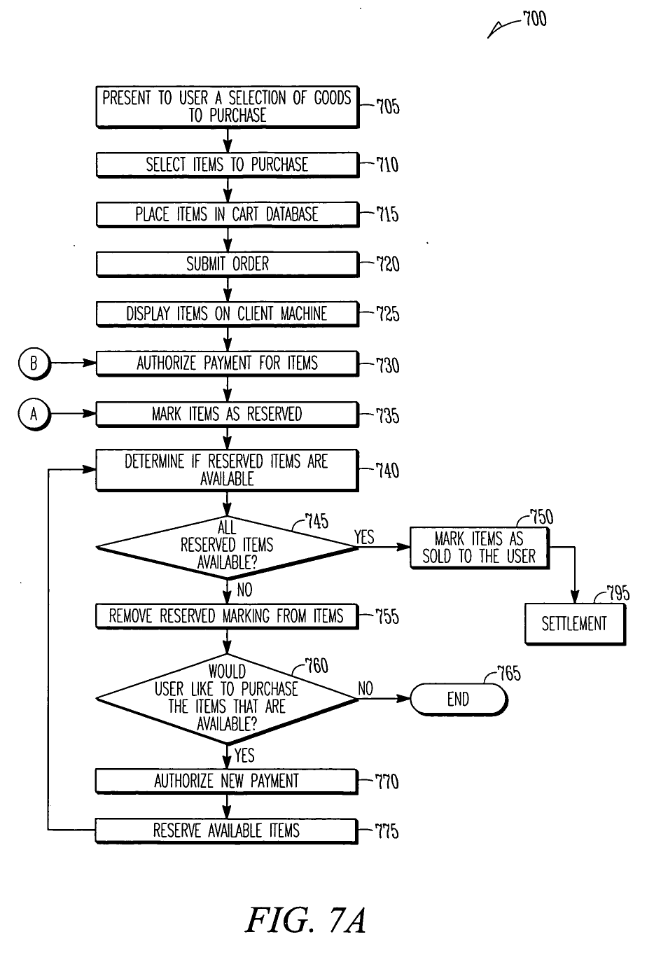

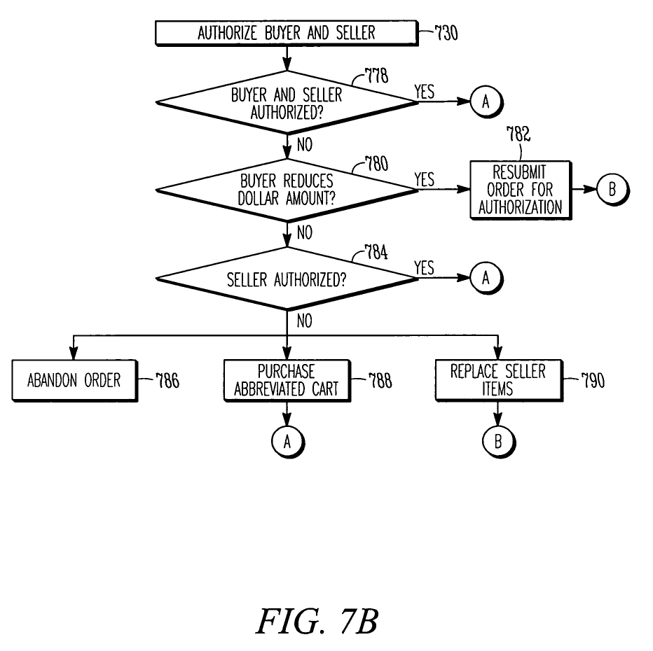

FIG. 7A illustrates an example embodiment of a process 700 that may be used by the client machine 620 to access the network-based transaction facility 642 and examine and select for purchase items via the checkout page 624. In one example embodiment, each operation in FIG. 7A may be executed in a separate module. In other embodiments, one or more operations in FIG. 7A may be combined into one or more modules. The items selected for purchase may be offered by more than one seller. These items are contained within the item data storage structure 644 and are displayed in block 705 (FIG. 7A) to the user on the client machine 620. When a user selects an item for purchase at block 710, that item is placed into the cart data storage structure 645 at block 715. When the user is finished perusing the items in the item data storage structure 644 of a particular network-based transaction facility 642, the user indicates that he would like to checkout and purchase the items in his cart (e.g., the cart data storage structure 645) at block 720. In an embodiment, the items in a cart may be referred to as a set of items.

Upon indicating that the user would like to checkout, the items in the cart data storage structure 645 along with corollary information such as shipping options are displayed by the checkout page 624 at block 725. After the display of the cart contents by the checkout page 624, and further upon an indication to pay by the user, the checkout page 624 sends a message 652 at block 730 to the payment server 646 to authorize payment for this user. This authorization request enters the payment gateway 648, is authorized by the payment processor 650, and an authorization 654 is transmitted back to the checkout page 624 through the payment gateway 648. The authorization may be for a credit card, debit card, personal check, an account with the payment server 646, or via some other financial instrument.

In one embodiment, if the payment authorization was not successful, nothing else need be done on the network-based transaction facility 642 since, in the example embodiment, placing the items into a user's cart does not affect the status of that item in the item data storage structure 644. That is, when an item is placed into the cart data storage structure 645, the checkout page 624 does not reserve the item, and the placement of the item in the cart does not prevent another consumer from placing it in their cart—even if there is only one unit of that item. Additionally, in a network based transaction facility 642 that maintains an inventory of items, the network-based transaction facility 642 does not reduce the inventory of the item when the item is placed into a cart.

If the payment authorization was successful, the checkout page 624 at block 735 calls the network-based transaction facility 642 to reserve the items in the user's cart data storage structure 645. The reservation of the item in the cart data storage structure 645 involves marking these items in the item data storage structure 644 so that no other person can reserve or purchase these particular units of these items. If all the items in the cart data storage structure 645 (e.g., the user's cart) are currently available at blocks 740, 745 in the item data storage structure 644, those items are marked as sold to this user at block 750, and the available units field 415 in the item table 400 is decremented. The result is that the user was able to purchase every item in his cart. In one embodiment, to complete the sale, the cart processor 622 is called by the checkout page 624 to process the cart items, and the cart processor 622 creates transaction, order, and/or invoice records. The cart processor 622 may further send a confirmatory email to the user. The checkout page 624 may paint a successful order page on the client machine 620. In another embodiment, for example in an online auction environment where the auction only lasts for a certain period of time, an item is considered as sold as soon as it is reserved, so as to avoid a situation in which an item is reserved before the end of the online auction, but the sale transaction is not completed until after the end of the online auction.

If not all of the items in the consumer's cart are available, the checkout page 624 first removes the reservations on the items in the cart at block 755, thereby making these items available again for other users to reserve for purchase. The checkout page 624 then sends a message back to the client machine 620 informing the user that not all items in the cart are available, and further inquires at block 760 if the user would like to purchase the items in the cart that are currently available in inventory, e.g. an abbreviated cart or a second set of items. If the user replies that he would not like to purchase the abbreviated cart list, nothing further need be done and the process ends at block 765 (for the same reasons as described supra in connection with the failure of payment authorization). However, if the user replies that he would like to purchase all (or at least some of) the items in his cart that are presently available, the checkout page 624 at block 770 transmits a message to the payment server 646 to authorize the new payment amount for the items in the abbreviated cart, and then a message is transmitted by the payment server 646 back to the checkout page 624 to once again reserve those items at block 775. This is because someone else, in the time period between informing the user that not all his cart items were available and receiving a message back at the transaction facility that the user wanted to purchase the abbreviated cart, may have purchased the last unit of one or more of the items in the user's abbreviated cart. This process 700 repeats, each time creating a new set of items, until the user is able to purchase all the items currently in his abbreviated cart, or he decides that he wants to purchase none of the remaining items in his abbreviated cart.

In a different embodiment in which payment authorization for the buyer was not successful (FIG. 7B; operation 778), instead of doing nothing as described supra (because simply placing items into a user's cart, without reserving those items, has no commercial effect on the system), the system 600 may allow the user to reduce the dollar amount of his cart at operation 780 in FIG. 7B in an attempt to receive a successful authorization. If the user decides to reduce the dollar amount of his order, and resubmits his order at operation 782, another authorization message 652 is sent to the payment server 646. If the authorization was not a success, the buyer can either discard the transaction or attempt to re-adjust the dollar amount of his cart. If, on the other hand, the buyer receives a successful authorization, an authorization success message 654 is sent back to the checkout page 624, and the checkout page at that point tries to reserve the items in the user's cart.

In another embodiment, in which once again more than one seller may be involved in the transaction facility 642, the payment server 646 authorizes not only the buyer's ability to pay the amount of the order, but also authorizes the transaction in relation to each seller (operation 778). As explained supra, if the buyer is successfully authorized, the checkout page 624 attempts to reserve the items in the cart, and if the buyer is not successfully authorized, nothing further need be done since placing the items in the buyer's cart does not reserve those items for the buyer. Regarding the seller, the payment server 646 may in this embodiment further authorize the one or more sellers who are offering the products that are in the buyer's cart. A seller may not be authorized by the payment server 646 for a variety of reasons, including instances in which the operator of the payment server 646 has had disputes or other problems with a particular seller.

In the case in which the payment server 646 successfully authorizes each seller, an authorization success message is sent back to the checkout page 624, and the checkout page 624 attempts to reserve the items in the user's cart. In the case in which one or more sellers are not successfully authorized at operation 784, a message is sent back to the checkout page 624, and in this embodiment, one of three actions may be taken. First, the buyer may chose not to purchase the abbreviated cart, and walk away from the order at operation 786. Second, the buyer may decide to purchase the abbreviated cart, and the checkout page 624 will then attempt to reserve the items in that abbreviated cart at operation 788. Third, the user may shop for items at operation 790 to replace the items that were offered by the seller that was not successfully authorized. If the buyer locates such replacement items, then the checkout page 624 sends a message to the payment server to authorize the additional order amount, and further to authorize the new seller.

In another embodiment, after the authorization process is complete, and after the checkout page 624 has sent a message to the cart processor 622 so that the cart processor creates transactions and orders, the cart processor 622 sends a message 662 to the payment server 646 at operation 795 to settle the transaction between the buyer and the one or more sellers involved in the transaction. The payment server 646 will then settle the account between the buyer and the one or more sellers. In one embodiment, both a buyer and a seller have accounts with the payment server 646, and the payment is moved from the buyer's account to the seller's account. In this embodiment, the buyer has a stored value or dollar amount of the available funds in his account that is used for this purpose. In another embodiment, the buyer is making the payment for his order with a credit card, and the payment server 646 settles the transaction between the buyer and the seller via normal credit card settlement procedures. Additionally, there are numerous further embodiments in which the payment server 646 settles the transaction by transferring the necessary funds from a financial account of the buyer to a financial account of a seller. After the payment server 646 has settled the transaction(s) between the buyer and the one or more sellers, the payment server 646 sends a settlement response 664 to the cart processor 622.

In one embodiment, the system 600 is a product catalog driven system. A product driven catalog system, for the purposes of this embodiment, means that a particular product is identified by a unique number, such as an ISBN number, and that product may be identified and associated with any seller offering that product by that number. In an alternative embodiment, the system 600 is not driven by such a catalog system, but rather by a database such as the item data storage structure 644 in FIG. 6. In either case, the system 600 is capable of providing the several embodiments disclosed supra of authorizing payment for a shopping cart; reserving the items in the cart after successful authorization so that a user may receive all the items in his shopping cart, decline to purchase the available items in his cart, or choose to purchase the abbreviated cart; and settling the transaction(s) among the buyer and the one or more sellers.

In the just described embodiments, the system 600 generally authorized an order, reserved the items in that order, and settled the order. However, other embodiments exist in which the sequence of the process steps may be different. For example, in another embodiment, the system 600 may first reserve the items in an order, authorize payment for that order, and then settle the order.

### Computer System

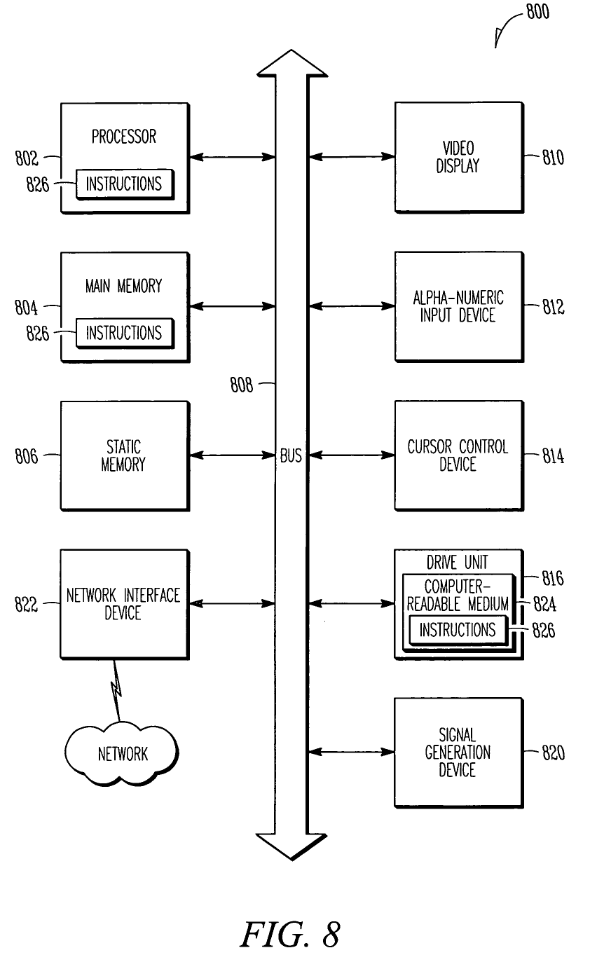

FIG. 8 shows a diagrammatic representation of a machine in the example form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alpha-numeric input device 812 (e.g. a keyboard), a cursor control device 814 (e.g. a mouse), a disk drive unit 816, a signal generation device 820 (e.g. a speaker) and a network interface device 822.

The disk drive unit 816 includes a machine-readable medium 824 on which is stored a set of instructions (e.g., software) 826 embodying any one, or all, of the methodologies described above. The software 826 is also shown to reside, completely or at least partially, within the main memory 804 and/or within the processor 802. The software 826 may further be transmitted or received via the network interface device 822. For the purposes of this specification, the term ” machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals.

Thus, a system and method for order processing and confirmation in a network-based transaction facility have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
presenting to a user items for purchase on a network-based transaction facility;
enabling the user to identify a first set of one or more of said items;
authorizing payment for said first set of items;
marking each item in said first set of items as reserved;
determining whether each item in said first set of items is available;
if each item in said first set of items is available, marking each item in said first set of items as sold; and
if each item in said first set of items is not available, presenting to said user an option to purchase a second set of items, said second set of items comprising one or more of the items in said first set of items that are available.

2. The method of claim 1, wherein if each item in said first set of items is not available, presenting to said user an option to purchase a third set of items, the third set of items comprising each item in said first set of items that is available.

3. The method of claim 1, wherein each item in said first set of items is marked as sold contemporaneously with marking each item in said first set of items as reserved.

4. The method of claim 1, further comprising presenting to said user an option not to purchase any of the items in said second set of items.

5. The method of claim 1, further comprising, if each item in said first set of items is not available:
removing said reservation from each item in said first set of items;
determining if said user would like to purchase one or more of the items in said second set of items;
authorizing payment for the one or more items in said second set of items;
marking the one or more items in said second set of items as reserved;
determining if the one or more items in said second set of items are available;
if the one or more items in said second set of items are available, marking the one or more items in said second set of items as sold; and
if the one or more items in said second set of items is not available, presenting to said user an option to purchase a fourth set of items, said fourth set of items comprising one or more of the items in said second set of items that are available.

6. The method of claim 1, further comprising:
removing said reservation from each item in said first set of items;
determining if said user would like to purchase each item in said second set of items;
authorizing payment for said second set of items;
marking each item in said second set of items as reserved;
determining if each item in said second set of items is available;
if each item in said second set of items is available, marking each item in said second set of items as sold; and
if each item in said second set of items is not available, presenting to said user an option to purchase a fifth set of items, said fifth set of items comprising one or more of the items in said second set of items that are available.

7. The method of claim 6, wherein if each item in said second set of items is not available, presenting to said user an option to purchase a sixth set of items; the sixth set of items comprising each item in said second set of items that is available.

8. The method of claim 5, wherein the one or more items in said second set of items is marked as sold contemporaneously with marking the one or more items in said second set of items as reserved.

9. The method of claim 5, further comprising repeating the operations in claim 5 until said user purchases one or more of the items in a particular set of items, or said user purchases none of the items in a particular set of items.

10. The method of claim 6, further comprising repeating the steps in claim 6 until said user purchases each item in a particular set of items, or said user purchases none of the items in a particular set of items.

11. The method of claim 1, wherein said network-based transaction facility is an online auction facility.

12. The method of claim 1, wherein the payment authorization for said first set of items is not successful, and further comprising:
enabling said user to reduce the number of items in said first set of items; and
authorizing payment for said reduced number of items.

13. The method of claim 1, wherein said items for purchase are offered by one or more sellers; and further comprising authorizing transactions of the one or more sellers.

14. The method of claim 13, wherein said authorization of at least one seller of the one or more sellers is not successful; and further comprising presenting to said user one or more options comprising:
enabling said user to buy the items for purchase offered by sellers who were successfully authorized;
enabling said user to cancel said order; and
enabling said user to replace the items from the one or more sellers who were not successfully authorized.

15. The method of claim 13, further comprising settling the transaction between said user and the one or more sellers.

16. The method of claim 15, wherein the settlement between said user and the one or more sellers comprises an account of said buyer containing a stored value of said user's available funds.

17. The method of claim 1, wherein said network-based transaction facility is a product catalog driven system.

18. The method of claim 1, wherein said items for purchase are stored in a database, and further wherein said database is independent of a product catalog.

19. The method of claim 1, wherein each item in said first set of items is reserved prior to authorizing payment for said first set of items.

20. A system comprising:
a module to present to a user items for purchase on a network-based transaction facility;
a module to enable the user to identify a first set of one or more of said items;
a module to authorize payment for said first set of items;
a module to mark each item in said first set of items as reserved;
a module to determine whether each item in said first set of items is available;
a module to mark each item in said first set of items as sold if each item in said first set of items is available; and
a module to present to said user an option to purchase a second set of items, said second set of items comprising one or more of the items in said first set of items that are available, if each item in said first set of items is not available.

21. The system of claim 20, further comprising a module to present to said user an option to purchase a third set of items, the third set of items comprising each item in said first set of items that is available, if each item in said first set of items is not available.

22. The system of claim 20, further comprising a module to mark each item in said first set of items as sold contemporaneously with marking each item in said first set of items as reserved.

23. The system of claim 20, further comprising a module to present to said user an option not to purchase any of the items in said second set of items.

24. The system of claim 20, further comprising:
a module to remove said reservation from each item in said first set of items;
a module to determine if said user would like to purchase one or more of the items in said second set of items;
a module to authorize payment for the one or more items in said second set of items;
a module to mark the one or more items in said second set of items as reserved;
a module to determine if the one or more items in said second set of items are available;
a module to mark the one or more items in said second set of items as sold, if the one or more items in said second set of items are available; and
a module to present to said user an option to purchase a fourth set of items, said fourth set of items comprising one or more of the items in said second set of items that are available, if the one or more items in said second set of items are not available.

25. The system of claim 20, further comprising:
a module to remove said reservation from each item in said first set of items;
a module to determine if said user would like to purchase each item in said second set of items;
a module to authorize payment for said second set of items;
a module to mark each item in said second set of items as reserved;
a module to determine if each item in said second set of items is available;
a module to mark each item in said second set of items as sold, if each item in said second set of items is available; and
a module to present to said user an option to purchase a fifth set of items, said fifth set of items comprising one or more of the items in said second set of items that are available, if each item in said second set of items is not available.

26. The system of claim 25, further comprising a module to present to said user an option to purchase a sixth set of items, the sixth set of items comprising each item in said second set of items that is available, if each item in said second set of items is not available.

27. The system of claim 24, further comprising a module to mark the one or more items in said second set of items as sold contemporaneously with marking the one or more items in said second set of items as reserved.

28. The system of claim 24, further comprising repeating the steps in claim 24 until said user purchases one or more of the items in a particular set of items, or said user purchases none of the items in a particular set of items.

29. The system of claim 25, further comprising repeating the steps in claim 25 until said user purchases each item in a particular set of items, or said user purchases none of the items in a particular set of items.

30. The system of claim 20, wherein said network-based transaction facility is an online auction facility.

31. The system of claim 20, wherein the payment authorization for said first set of items is not successful, and further comprising:
a module to enable said user to reduce the number of items in said first set of items; and
a module to authorize payment for said reduced number of items.

32. The system of claim 20, wherein said items for purchase are offered by one or more sellers; and further comprising authorizing transactions of the one or more sellers.

33. The system of claim 32, wherein said authorization of at least one seller of the one or more sellers is not successful; and further comprising a module to present to said user one or more options to:
enable said user to buy the items for purchase offered by sellers who were successfully authorized;
enable said user to cancel said order; and
enable said user to replace the items from the one or more sellers who were not successfully authorized.

34. The system of claim 32, further comprising settling the transaction between said user and the one or more sellers.

35. The system of claim 34, wherein the settlement between said user and the one or more sellers comprises an account of said buyer containing a stored value of said user's available funds.

36. The system of claim 20, wherein said network-based transaction facility is a product catalog driven system.

37. The system of claim 20, wherein said items for purchase are stored in a database, and further wherein said database is independent of a product catalog.

38. The system of claim 20, wherein each item in said first set of items is reserved prior to authorizing payment for said first set of items.

39. A machine-readable medium comprising instructions for executing a process comprising:
presenting to a user items for purchase on a network-based transaction facility;
enabling the user to identify a first set of one or more of said items;
authorizing payment for said first set of items;
marking each item in said first set of items as reserved;
determining whether each item in said first set of items is available;
if each item in said first set of items is available, marking each item in said first set of items as sold; and
if each item in said first set of items is not available, presenting to said user an option to purchase a second set of items, said second set of items comprising one or more of the items in said first set of items that are available.

40. The machine-readable medium of claim 39, wherein if each item in said first set of items is not available, and further comprising instructions for presenting to said user an option to purchase a third set of items, the third set of items comprising each item in said first set of items that is available.

41. The machine-readable medium of claim 39, wherein each item in said first set of items is marked as sold contemporaneously with marking each item in said first set of items as reserved.

42. The machine-readable medium of claim 39, further comprising instructions for presenting to said user an option not to purchase any of the items in said second set of items.

43. The machine-readable medium of claim 39, further comprising instructions for:
removing said reservation from each item in said first set of items;
determining if said user would like to purchase one or more of the items in said second set of items;
authorizing payment for the one or more items in said second set of items;
marking the one or more items in said second set of items as reserved;
determining if the one or more items in said second set of items are available;
if the one or more items in said second set of items are available, marking the one or more items in said second set of items as sold; and
if the one or more items in said second set of items is not available, presenting to said user an option to purchase a fourth set of items, said fourth set of items comprising one or more of the items in said second set of items that are available.

44. The machine-readable medium of claim 39, further comprising instructions for:
removing said reservation from each item in said first set of items;
determining if said user would like to purchase each item in said second set of items;
authorizing payment for said second set of items;
marking each item in said second set of items as reserved;
determining if each item in said second set of items is available;
if each item in said second set of items is available, marking each item in said second set of items as sold; and
if each item in said second set of items is not available, presenting to said user an option to purchase a fifth set of items, said fifth set of items comprising one or more of the items in said second set of items that are available.

45. The machine-readable medium of claim 44, wherein if each item in said second set of items is not available, and further comprising instructions for presenting to said user an option to purchase a sixth set of items; the sixth set of items comprising each item in said second set of items that is available.

46. The machine-readable medium of claim 43, wherein the one or more items in said second set of items is marked as sold contemporaneously with marking the one or more items in said second set of items as reserved.

47. The machine-readable medium of claim 43, further comprising instructions for repeating the steps in claim 43 until said user purchases one or more of the items in a particular set of items, or said user purchases none of the items in a particular set of items.

48. The machine-readable medium of claim 44, further comprising instructions for repeating the steps in claim 44 until said user purchases each item in a particular set of items, or said user purchases none of the items in a particular set of items.

49. The machine-readable medium of claim 39, wherein said network-based transaction facility is an online auction facility.

50. The machine-readable medium of claim 39, wherein the payment authorization for said first set of items is not successful, and further comprising instructions for:
enabling said user to reduce the number of items in said first set of items; and
authorizing payment for said reduced number of items.

51. The machine-readable medium of claim 39, wherein said items for purchase are offered by one or more sellers; and further comprising instructions for authorizing transactions of the one or more sellers.

52. The machine-readable medium of claim 51, wherein said authorization of at least one seller of the one or more sellers is not successful; and further comprising instructions for presenting to said user one or more options to:
enable said user to buy the items for purchase offered by sellers who were successfully authorized;
enable said user to cancel said order; and
enable said user to replace the items from the one or more sellers who were not successfully authorized.

53. The machine-readable medium of claim 51, further comprising instructions for setting the transaction between said user and the one or more sellers.

54. The machine-readable medium of claim 53, wherein the settlement between said user and the one or more sellers comprises an account of said buyer containing a stored value of said user's available funds.

55. The machine-readable medium of claim 39, wherein said network-based transaction facility is a product catalog driven system.

56. The machine-readable medium of claim 39, wherein said items for purchase are stored in a database, and further wherein said database is independent of a product catalog.

57. The machine-readable medium of claim 39, wherein each item in said first set of items is reserved prior to authorizing payment for said first set of items.
